(19) United States
(12) Patent Application Publication
(10) Pub. No.: US 2025/0173395 A1
(43) Pub. Date: May 29, 2025

(54) COORDINATE ROTATION PROCESSING APPARATUS, PHASE-ONLY CORRELATION COMPUTING APPARATUS, METHODS OF THE SAME, AND COMPUTER-READABLE STORAGE MEDIUM

(71) Applicant: CANON KABUSHIKI KAISHA, Tokyo (JP)

(72) Inventors: MASAHIKO MIZOGUCHI, Kanagawa (JP); Ken Ishizuka, Tokyo (JP)

(21) Appl. No.: 18/952,877

(22) Filed: Nov. 19, 2024

(30) Foreign Application Priority Data
Nov. 29, 2023 (JP) 2023-202190

(51) Int. Cl. G06F 17/16; G06F 5/01

(52) U.S. Cl. CPC G06F 17/16; G06F 5/01

(57) ABSTRACT

An apparatus generates, by a calculating processing, a normalized first vector having a polar angle of a first input vector and a magnitude obtained by multiplying a scaling factor with a magnitude of a normalized vector, and an output vector having a polar angle obtained by rotating the normalized first vector by a polar angle of a second input vector and a magnitude obtained by multiplying the scaling factor with a magnitude of the normalized first vector, wherein the calculating processing, in accordance with input of two vectors, outputs a vector having a polar angle obtained by rotating one of the two vectors by a polar angle of another one of the two vectors and a magnitude obtained by multiplying a scaling factor with a magnitude of the one of the two vectors.

### BACKGROUND

### Technical Field

The aspect of the embodiments relates to a coordinate rotation processing apparatus, a phase-only correlation computing apparatus, methods thereof, and a computer-readable storage medium.

### Description of the Related Art

Conventionally, in the communication field and the image and video signal processing field, there is a technique for associating (matching and registration) two signals and images. For example, distance measurement and three-dimensional measurement can be performed by performing registration of an object in two images on the left side and the right side in stereo vision as in Japanese Patent Laid-Open No. 2010-071922. Further, positioning of a substrate of a lithography apparatus, for example, is performed by searching for and registering a recorded marker image as in Japanese Patent Laid-Open No. 2017-015994 based on a captured image. In recent years, there has been an increasing demand for robust sub pixel registration accuracy which is more accurate than that of the level of the pixels of a captured image, and that does not depend on an image capturing target or an image capturing condition, in order to improve the accuracy of the above-described measurement and registration. Methods using a phase-only correlation function in order to satisfy this demand are known (Japanese Patent Laid-Open No. 2010-071922 and also “Improving the performance of sub-pixel image matching based on phase-only correlation method” by Sei Nagashima, Takafumi Aoki, Tatsuo Higuchi, and Koji Kobayashi, No. 218 Workshop (2004.10.9) of the Tohoku Chapter of the Society of Instrument and Control Engineers, document number 218-15).

Meanwhile, in a method using a phase-only correlation function, a calculation amount for a two-dimensional discrete Fourier transform and a calculation amount for a phase calculation (vector calculation) for two images are large. As a method of lightweight vector calculation, a coordinate data rotation calculator called “CORDIC”, which is capable of realizing coordinate rotation simply by repeating bit shifting and addition/subtraction, is disclosed in “The CORDIC trigonometric computing technique” by J. E. Volder, IRE Transactions on Electronic Computers, EC-8:330-334, 1959. Further, Japanese Patent No. 3283504 and Japanese Patent Laid-Open No. 2017-123057 disclose vectoring mode CORDIC and rotation mode CORDIC. In vectoring mode CORDIC, rectangular coordinates are transformed into polar coordinates, and the distance (absolute value) from the origin of the two-dimensional coordinates is outputted. In rotation mode CORDIC, information of a polar angle (argument, vector angle) obtained in vectoring mode is inputted as a rotation angle, and rectangular coordinates obtained by rotating other rectangular coordinates through the rotation angle are outputted.

In phase-only correlation computing, it is necessary to generate a normalized output vector in which the difference between polar angles of two input vectors is set as a new polar angle. Japanese Patent No. 3283504 does not suggest any configuration for generating such an output vector. Further, in Japanese Patent Laid-Open No. 2017-123057, although it is possible to obtain an output vector having the difference between the polar angles of two input vectors, a circuit for performing a normalization process in order to obtain a normalized output vector (a circuit for performing absolute value calculation and division) is required, and the circuit scale increases.

### SUMMARY

According to an aspect of the embodiments, there is provided an apparatus, comprising: a calculating processing unit configured to, in accordance with input of two vectors, output a vector having a polar angle that is a result of rotating one of the two vectors by a polar angle of the other vector and a magnitude that is a result of multiplying a scaling factor with a magnitude of the one of the two vectors; a first processing unit configured to, using the calculating processing unit, from a first input vector and a normalized vector whose rectangular coordinates are represented by (N, 0), generate a normalized first vector having a polar angle of the first input vector and a magnitude that is a result of multiplying the scaling factor with a magnitude of the normalized vector; and a second phase processing unit configured to, using the calculating processing unit, from a second input vector and the normalized first vector, generate an output vector having a polar angle that is a result of rotating the normalized first vector by a polar angle of the second input vector and a magnitude that is a result of multiplying the scaling factor with a magnitude of the normalized first vector.

Further features of the disclosure will become apparent from the following description of exemplary embodiments with reference to the attached drawings.

### BRIEF DESCRIPTION OF THE DRAWINGS

FIG. 1A is a diagram illustrating a configuration example of a coordinate rotation processing apparatus according to a first embodiment.

FIG. 1B is a diagram illustrating a configuration example of a coordinate rotation processing apparatus according to the first embodiment.

FIG. 2 is a block diagram illustrating a configuration example of a vectoring-rotation CORDIC processing unit.

FIG. 3 is a block diagram illustrating a configuration example of a coordinate rotation calculation unit constituting a CORDIC processing unit.

FIG. 4A is a flowchart for describing coordinate rotation processing of the first embodiment.

FIG. 4B is a flowchart for describing coordinate rotation processing of a second embodiment.

FIG. 5A is a diagram illustrating vector processing of first phase processing.

FIG. 5B is a diagram illustrating vector processing of second phase processing.

FIG. 5C is a diagram illustrating vector processing of second phase processing.

FIG. 6 is a block diagram illustrating a configuration example of a phase-only correlation computing apparatus according to a third embodiment.

FIG. 7A is a flowchart for describing phase-only correlation computing processing according to the third embodiment.

FIG. 7B is a flowchart for describing phase-only correlation computing processing according to the third embodiment.

FIG. 8A is a block diagram illustrating a configuration example of a phase-only correlation computing apparatus according to a fourth embodiment.

FIG. 8B is a block diagram illustrating a configuration example of a coordinate rotation processing unit according to the fourth embodiment.

FIG. 9 is a flowchart for describing phase-only correlation computing processing according to the fourth embodiment.

FIG. 10 is a block diagram illustrating a configuration example of a phase-only correlation computing apparatus according to a fifth embodiment.

FIG. 11 is a flowchart for describing phase-only correlation computing processing according to the fifth embodiment.

FIG. 12A is a flowchart for describing another example of phase-only correlation computing processing according to the fifth embodiment.

FIG. 12B is a flowchart for describing another example of phase-only correlation computing processing according to the fifth embodiment.

FIG. 13 is a block diagram illustrating a configuration example of a coordinate rotation processing apparatus according to a sixth embodiment.

FIG. 14A is a diagram illustrating vector data compression processing according to the sixth embodiment.

FIG. 14B is a diagram illustrating vector data compression processing according to a seventh embodiment.

FIG. 14C is a diagram illustrating vector data compression processing according to the seventh embodiment.

FIG. 15 is a block diagram illustrating a configuration example of a coordinate rotation processing apparatus according to an eighth embodiment.

FIG. 16A is a diagram illustrating fixed point data processing according to the eighth embodiment.

FIG. 16B is a diagram illustrating fixed point data processing according to the eighth embodiment.

FIG. 16C is a diagram illustrating fixed point data processing according to the eighth embodiment.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

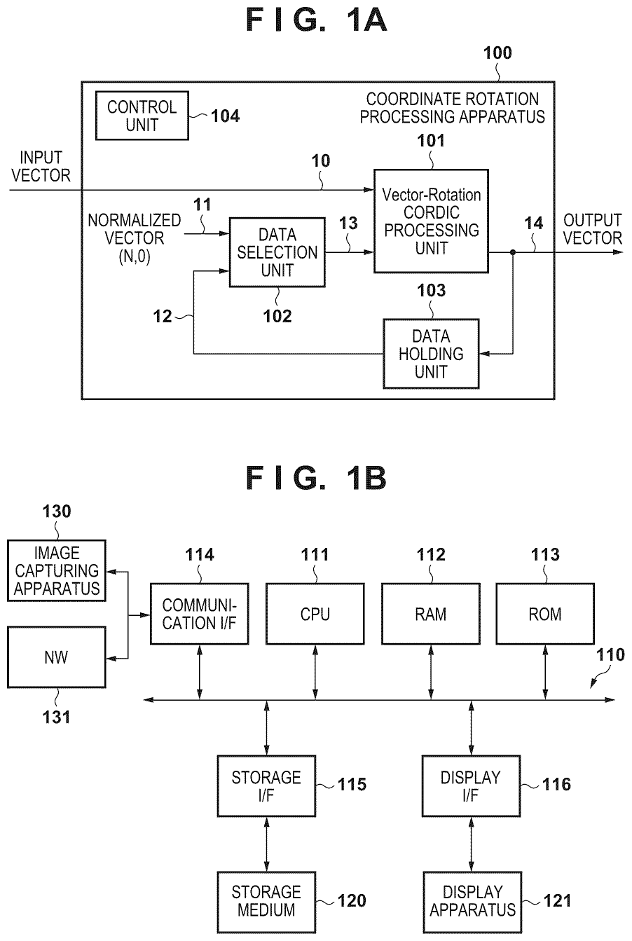

FIG. 1A and FIG. 1B are diagrams illustrating a configuration example of a coordinate rotation processing apparatus according to the present embodiment. FIG. 1A is a functional block diagram illustrating functional units corresponding to respective processes performed by a coordinate rotation processing apparatus 100 of the present embodiment. FIG. 1B is a block diagram illustrating an example of a hardware configuration of a data processing apparatus 110 that implements the coordinate rotation processing apparatus 100 illustrated in FIG. 1A.

As illustrated in FIG. 1B, the data processing apparatus 110 includes a CPU 111, a RAM 112, a ROM 113, a communication I/F (interface) 114, a storage I/F 115, and a display I/F 116, and can be realized by an information processing apparatus such as a so-called personal computer. The data processing apparatus 110 can be connected to a storage medium 120 such as a hard disk or a semiconductor memory via the storage I/F 115, and can be connected to a display apparatus 121 such as a liquid crystal display via the display I/F 116. The data processing apparatus 110 can be connected to, for example, an image capturing apparatus 130 and various NWs (networks) 131 via the communication I/F 114.

The ROM 113 holds various programs and the like including a data processing program according to the present embodiment. A program in the ROM 113 is loaded into the RAM 112 and executed by the CPU 111. In addition to programs being loaded thereinto, the RAM 112 is used as a working area of the CPU 111 and temporarily stores inputted image data, partly processed image data, and the like.

The communication I/F 114 performs communication with, for example, the image capturing apparatus 130 and the networks 131. For example, when the communication I/F 114 receives image data or the like transmitted from the image capturing apparatus 130 or the networks 131, the image data is temporarily stored in the RAM 112 under the control of the CPU 111. The CPU 111 performs various kinds of image processing and the like on the image data as needed, and displays the image data on a screen of the display apparatus 121 via the display I/F 116 or stores the image data on the storage medium 120 via the storage I/F 115.

The CPU 111 can perform various kinds of processing and control in the data processing apparatus 110, and can execute the data processing program and the like according to the present embodiment to perform various kinds of image processing including data transformation processing as described later. In the present embodiment, an example is given in which the processing of each functional unit of the coordinate rotation processing apparatus 100 shown in FIG. 1A is realized by software processing in which the CPU 111 executes a program; however, of course, the processing of each functional unit may be realized by a hardware configuration such as a respective circuit or the like. Further, each functional unit may be realized by one apparatus or may be realized by a plurality of apparatuses.

As illustrated in FIG. 1A, the coordinate rotation processing apparatus 100 includes a vectoring-rotation CORDIC processing unit (hereinafter, described as a CORDIC processing unit 101), a data selection unit 102, a data holding unit 103, and a control unit 104.

First, the CORDIC processing unit 101 will be described. In a case where processing is completed in vectoring mode processing and rotation mode processing and a polar angle is not required externally, it is redundant to transform information of the rotation direction into a polar angle by vectoring mode processing, and return to the original rotation direction information by the rotation mode processing. When the rotation direction information is directly sent from vectoring mode processing to the rotation mode processing, a coordinate rotation calculation can be efficiently performed, and on top of that, it becomes possible to perform processing with lower latency in proportion to the degree to which the transformation to/inverse transformation from a polar angle become unnecessary.

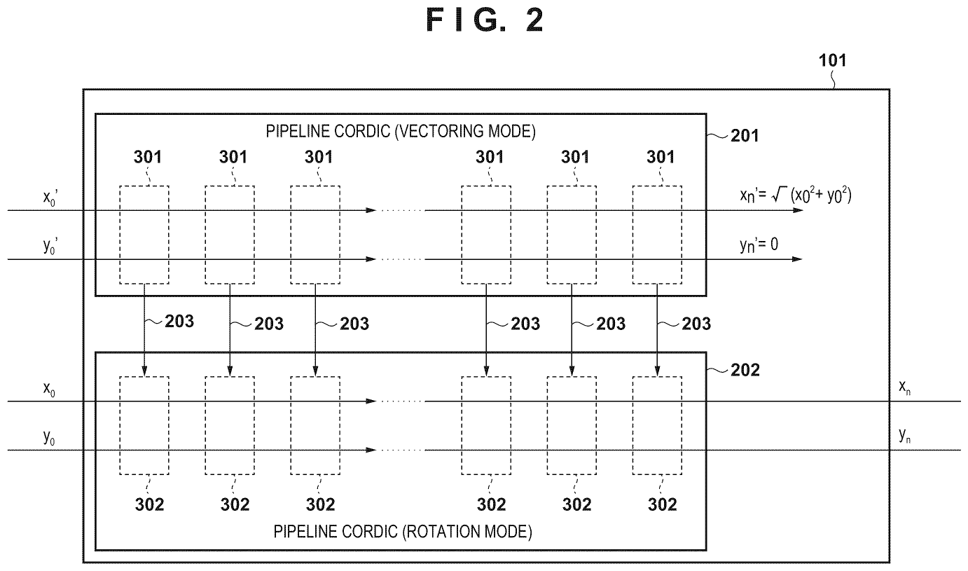

FIG. 2 illustrates a configuration example of the CORDIC processing unit 101. As illustrated in FIG. 2, there are two pipelines: a pipeline CORDIC 201 constituted by a coordinate rotation calculation unit that performs vectoring mode processing, and a pipeline CORDIC 202 constituted by a coordinate rotation calculation unit that performs rotation mode processing. Between the corresponding coordinate rotation calculation units of each step of these two pipelines, binary rotation direction information 203 representing the rotation direction is sent from vectoring mode (pipeline CORDIC 201) to the rotation mode (pipeline CORDIC 202). The pipeline CORDIC 201 (vectoring mode processing) rotates the input vector (x₀′, y₀′) by the polar angle of the input vector by repeating a plurality of rotation processes described later, and causes the result to converge upon a vector having a magnitude that is a multiple of a scaling factor. The pipeline CORDIC 202 (rotation mode processing) repeats the rotation processing a plurality of times in accordance with the rotation direction information 203, and thereby performs rotation processing a plurality of times on the input vector (x₀, y₀) similarly to the vectoring mode processing. Consequently, from the pipeline CORDIC 202, a vector, in which the input vector (x₀, y₀) is rotated by the polar angle of the input vector (x₀′, y₀′) and its magnitude is multiplied by a scaling factor, is obtained.

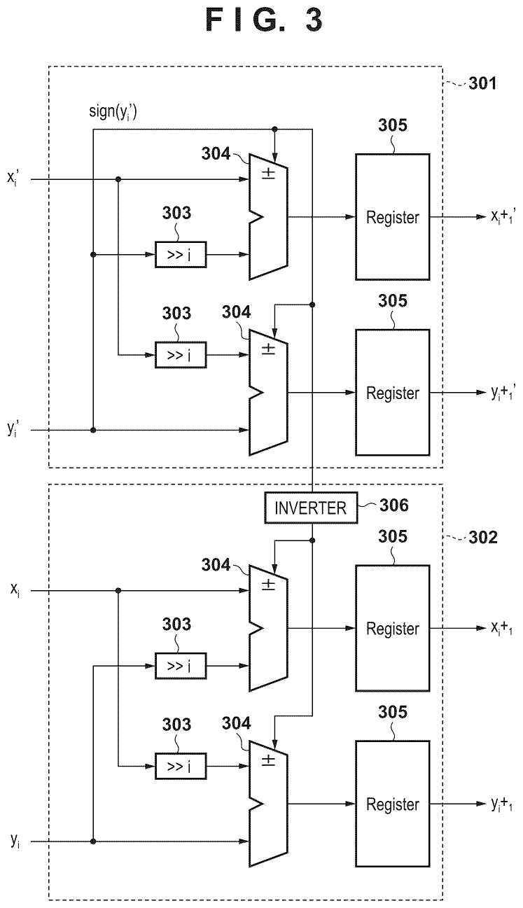

FIG. 3 illustrates a circuit configuration of an i-th step (i=0, 1, 2, 3, . . . ) of a pipeline. FIG. 3 illustrates a coordinate rotation calculation unit 301 that performs vectoring mode processing in the i-th step and a coordinate rotation calculation unit 302 that performs rotation mode processing in the i-th step. The coordinate rotation calculation unit 301 and the coordinate rotation calculation unit 302 have the same circuit configuration. However, a sign bit sign (yᵢ′) is inputted to an adder-subtractor 304 of the coordinate rotation calculation unit 301, and a value resulting from inverting the sign bit sign (yᵢ′) by using an inverter 306 is inputted into the adder-subtractor 304 of the coordinate rotation calculation unit 302. That is, the sign bit sign (yᵢ′) of yᵢ′ in each step of vectoring mode processing is used as the rotation direction information 203 representing the rotation direction of each step of rotation mode processing. The input data xi′, yᵢ′ is vector coordinate data, and the coordinate rotation calculation unit 301 receives the data and performs vectoring mode calculation by the two shift circuits 303 and the two adder-subtractors 304. The respective calculation results are stored in registers 305 as output data xᵢ₊₁′ and yᵢ₊₁′, and are provided to the next stage (i+1th step). In addition, the input data xᵢ, yᵢ is rotation coordinate data, and the coordinate rotation calculation unit 302 performs rotation mode calculation on the input rotation coordinate data by the two shift circuits 303 and the two adder-subtractors 304.

The direction of the coordinate rotation by the adder-subtractors 304 of the coordinate rotation calculation unit 301 and the coordinate rotation calculation unit 302 are determined by the sign bit of yᵢ′ data, that is, sign (yᵢ′). For example, assuming that the vector coordinate data (xᵢ′, yᵢ′) is in the first quadrant or the fourth quadrant, a rotation calculation is performed in which if sign (yᵢ′)=0, a clockwise rotation is performed, and if sign (yᵢ′)=1, a counterclockwise rotation is performed. Meanwhile, in the coordinate rotation calculation unit 302, since sign (yᵢ′) is inverted by the inverter 306, a rotation calculation is performed in which if sign (yᵢ′)=0, counterclockwise rotation is performed, and if sign (yᵢ′)=1, a clockwise rotation is performed. The calculation processing by the coordinate rotation calculation unit 301 and the coordinate rotation calculation unit 302 is the same, and so calculation by the coordinate rotation calculation unit 302 will be described below. For example, a rotation calculation for obtaining xᵢ₊₁, yᵢ₊₁ by a clockwise rotation of the rotation coordinate data xᵢ, yᵢ in the adder-subtractor 304 is as follows.

xᵢ₊₁=xᵢ+(2⁻ⁱ)·yᵢ

yᵢ₊₁=yᵢ−(2⁻ⁱ)·xᵢ (1)

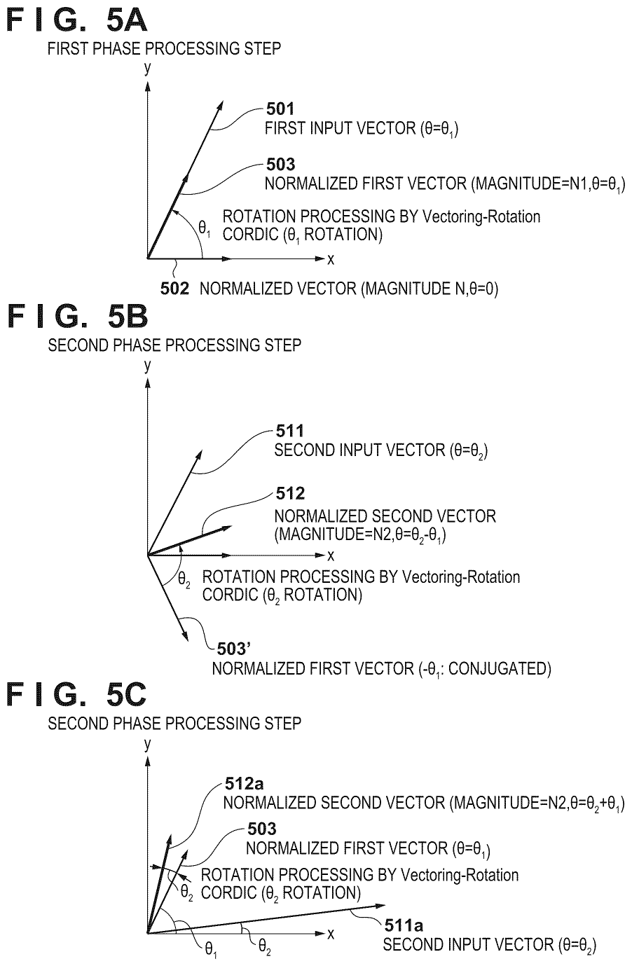

The data on the left side of Equation (1) is input data of a calculation unit of the next stage (i+1th step). Further, the data obtained by multiplying by (2⁻ⁱ) on the right side of Expression (1) is obtained by the shift circuits 303 which shifts xᵢ, yᵢ, which is the multiplication target data, to right by i-bit. Meanwhile, in the case of a counterclockwise rotation, the calculation is performed by switching the addition to subtraction and the subtraction to addition on the right side of Expression (1). According to the above circuit configuration, in the case of an n-step pipeline, in vectoring mode processing, n rotations are performed so as to cause the polar angle of the input vector (x₀′, y₀′) to converge upon 0° (yₙ′=0). Then, in the rotation mode processing, the same rotations as the n rotations of the vectoring mode processing are applied to the input vector (x₀, y₀). In the rotation mode processing, since a signal obtained by inverting sign (yᵢ′) by the inverter 306 is used, the input vector (x₀, y₀) is rotated across the polar angle in the direction of the polar angle of the input vector (x₀′, y₀′) by the polar angle, as will be described later with reference to FIGS. 5A and 5B.

As described above, a new vector obtained by rotating the vector inputted into the rotation mode processing (pipeline CORDIC 202) based on information of the polar angle of the vector inputted into the vectoring mode processing (pipeline CORDIC 201) is generated. Although CORDIC has been described above as a pipeline configuration, the present disclosure is not limited to such a pipeline configuration, and can be applied to recursive configuration CORDIC, and similar advantages can be obtained.

In FIGS. 1A and 1B, vector input rectangular coordinate data 10 corresponds to the vector coordinate data described above, and rotation input rectangular coordinate data 13 corresponds to the rotation coordinate data described above. Therefore, the CORDIC processing unit 101 generates a vector (rotation output rectangular coordinate data 14) obtained by rotating the rotation target vector (rotation input rectangular coordinate data 13) by the polar angle of the input vector (vector input rectangular coordinate data 10) of the coordinate rotation processing apparatus 100. In first phase processing described later, the rotation output rectangular coordinate data 14 is stored in the data holding unit 103 as a normalized first vector (described later). In second phase processing, which will be described later, the rotation output rectangular coordinate data 14 is outputted as an output vector (described later) of the coordinate rotation processing apparatus 100. The data selection unit 102 selects either a normalized vector having a normalized magnitude of N (N,0) or output rectangular coordinate data 12 read from the data holding unit 103, and supplies it to the CORDIC processing unit 101 as the rotation input rectangular coordinate data 13. More specifically, the data selection unit 102 selects the normalized vector in the first phase processing described later, and selects the output rectangular coordinate data 12 read from the data holding unit 103 in the second phase processing described later. The control unit 104 uses the CORDIC processing unit 101, the data selection unit 102, and the data holding unit 103 to perform control to obtain an output vector whose polar angle is made to be the difference between the polar angles of the first input vector and the second input vector and having a magnitude independent of the first input vector and the second input vector.

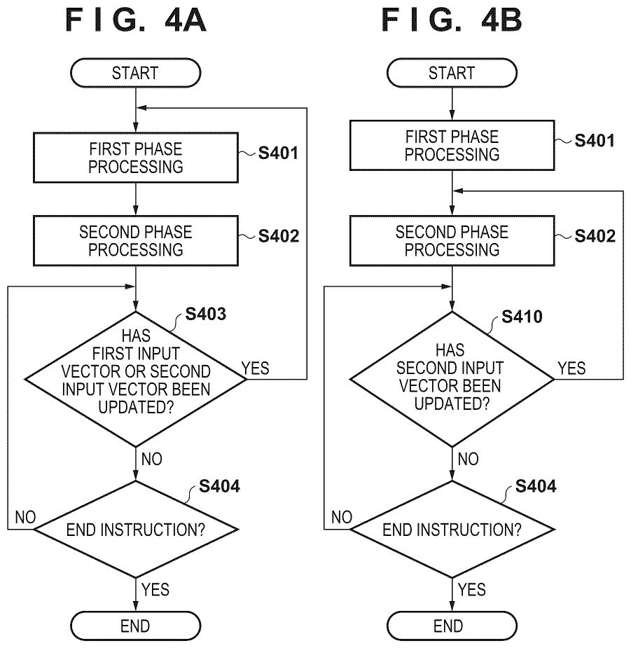

FIG. 4A is a flowchart for describing coordinate rotation processing performed by the coordinate rotation processing apparatus 100 according to the first embodiment. FIG. 5A, FIG. 5B and FIG. 5C are image diagrams of vector rotation in the first phase processing and the second phase processing. Processing of the coordinate rotation processing apparatus 100 will be described below with reference to these drawings. In the present embodiment, an output vector, in which the phase difference between the first input vector and the second input vector is made as a polar angle with a normalized magnitude independent of the first input vector and the second input vector, is obtained by two processing steps: first phase processing (step S401) and second phase processing (step S402).

### (First Phase Processing)

In step S401, the control unit 104 executes first phase processing. In the first phase processing, the control unit 104 inputs a first input vector as the vector input rectangular coordinate data 10 and a normalized vector (N, 0) having a magnitude of N as the rotation input rectangular coordinate data 13 to the CORDIC processing unit 101. Consequently, the CORDIC processing unit 101 obtains the rotation output rectangular coordinate data 14, which has the polar angle of the first input vector and a magnitude N1, obtained by multiplying the magnitude N by a scaling factor. Hereinafter, the rotation output rectangular coordinate data 14 obtained by the first phase processing is referred to as a normalized first vector. Here, the scaling factor is a factor corresponding to the CORDIC processing step number, and the magnitude N1 of the normalized first vector is expressed by N1=N (1+2⁻²ⁱ)^{1/2}, where i is the number of rotations. Therefore, the magnitude N1 of the normalized first vector depends on the number of rotations i and does not depend on the input vector.

A vector image of the first phase processing is illustrated in FIG. 5A. Assuming that the polar angle of a first input vector 501 is θ₁, the normalized vector 502 (θ=0) is rotated by θ₁ by the rotation processing performed by the CORDIC processing unit 101, and a normalized first vector 503 having a polar angle of θ₁ is generated, as illustrated in the drawing. The obtained normalized first vector 503 is stored in the data holding unit 103. Note that the data holding unit 103 may be an internal memory comprising an SRAM and a register, or may be an external memory such as a DRAM or an external storage apparatus.

### (Second Phase Processing)

In step S402, the control unit 104 executes second phase processing. In the second phase processing, the control unit 104 inputs a second input vector to the CORDIC processing unit 101 as the vector input rectangular coordinate data 10. Further, the data selection unit 102 selects the normalized first vector stored in the data holding unit 103 by the first phase processing (step S401). At this time, the data selection unit 102 generates conjugate data of the selected normalized first vector (data obtained by inverting the sign of the Y axis data in rectangular coordinates) and provides the generated conjugate data to the CORDIC processing unit 101 as the rotation input rectangular coordinate data 13. Thus, a normalized second vector whose polar angle is made to be the phase difference between the first input vector and the second input vector is obtained as the output vector. The magnitude N2 of the output vector obtained by the second phase processing is a value obtained by multiplying N1 by a scaling factor, and is expressed by N2=N1 (1+2⁻²ⁱ)^{1/2}, where i is the number of rotations. As described above, the magnitude N2 of the normalized second vector depends only on the number of rotations i and does not depend on the input vector, similarly to the magnitude N1 of the normalized first vector.

A vector image of the second phase processing is illustrated in FIG. 5B. As described above, a second input vector 511 as the vector input rectangular coordinate data 10 and the conjugated normalized first vector 503′ (θ=−θ₁) obtained by conjugating the normalized first vector 503 as the rotation input rectangular coordinate data 13 are inputted to the CORDIC processing unit 101. Assuming that the polar angle of the second input vector 511 is θ₂, the conjugated normalized first vector 503′ is rotated by θ₂ by the rotation processing performed by the CORDIC processing unit 101, and a normalized second vector 512 having a polar angle of θ₂-θ₁ is generated, as illustrated in the drawing. In this way, the normalized second vector 512 is obtained from the coordinate rotation processing apparatus 100 as an output vector.

In step S403, the control unit 104 determines whether to newly execute the first phase processing and the second phase processing. When the first input vector or the second input vector has been newly inputted or updated (YES in step S403), the control unit 104 determines to newly execute the first phase processing and the second phase processing. In this case, the processing returns to step S401, and the first phase processing and the second phase processing described above are executed to generate a new output vector. On the other hand, when an end instruction is received (YES in step S404), the processing ends.

As described above, in the first embodiment, the generation of a vector whose polar angle is made to be the phase difference between the two vectors (the first input vector and the second input vector) and which has normalized magnitude (N2) is realized by a small circuit scale vectoring-rotation CORDIC configuration. In the first phase processing and the second phase processing, one first input vector and one second input vector are described as being processed, but the aspect of the embodiments is not limited thereto. For example, a plurality of different first input vectors may be processed in the first phase processing to obtain a plurality of normalized first vectors, and a plurality of output vectors may be obtained using one second input vector and each of the plurality of normalized first vectors in the second phase processing. Alternatively, one first input vector may be processed in the first phase processing to obtain a normalized first vector, and a plurality of output vectors may be obtained using each of the plurality of different second input vectors and the normalized first vector in the second phase processing. For example, a plurality of different first input vectors may be processed in the first phase processing to obtain a plurality of normalized first vectors, and a plurality of output vectors may be obtained using pairs having a particular relatedness among a plurality of second input vectors and the plurality of normalized first vectors in the second phase processing.

Further, in the above description, in order to obtain the vector of the phase difference, the conjugate data of the normalized first vector in the second phase processing (step S402) is made to be the rotation input rectangular coordinate data 13, but the aspect of the embodiments is not limited thereto. For example, the conjugation process can also be performed by rotating the normalized vector in the reverse direction in the first phase processing (step S401). More specifically, in the first phase processing, the coordinate rotation calculation unit 302 that performs the rotation mode processing inputs the rotation direction information 203 to the adder-subtractor 304 without inversion (without passing it through the inverter 306), thereby obtaining the above-described conjugated normalized first vector. Then, in the second phase processing, the rotation direction information 203 is inverted by the inverter 306 and inputted to the adder-subtractor 304, whereby an output vector having the phase difference as a polar angle is obtained.

Further, it is also possible to generate a vector obtained by phase addition instead of phase difference by using the normalized first vector as it is without conjugation as described above. For example, as illustrated in FIG. 5C, a second input vector 511a having the polar angle θ of θ₂ and the normalized first vector 503 (θ=θ₁) are inputted to the CORDIC processing unit 101, so that the normalized first vector 503 is further rotated by θ₂ in the same direction. As a result, the polar angle of a normalized second vector 512a (output vector) becomes θ₁+θ₂. In this case as well, the magnitude is N2 as in the case of the phase difference.

### Second Embodiment

In the second embodiment, a process applicable to a case where one of the two input vectors, the first input vector and the second input vector, changes will be described. Here, vector data in which no change occurs is used as the first input vector. The configuration of the coordinate rotation processing apparatus 100 is similar to that of the first embodiment (FIG. 1A to FIG. 3).

FIG. 4B is a flowchart illustrating coordinate rotation processing performed by the coordinate rotation processing apparatus 100 according to the second embodiment. A first phase processing, for the first time, and second phase processing, for the first time, are the same as those in the first embodiment, and the control unit 104 executes the first phase processing (step S401) and the second phase processing (step S402). In the present embodiment, it is assumed that the second input vector is changed, and in step S410, the second input vector is updated as a condition for executing a new process. Further, since there is no change in the first input vector, the second phase processing is to be performed in this new processing. Therefore, if it is determined that the second input vector has been updated (YES in step S410), the control unit 104 omits the first phase processing and executes the second phase processing (step S402). When an end instruction is received (YES in step S404), the processing ends.

As described above, in the second embodiment, the first phase processing is executed in accordance with the input of the first input vector, and thereafter, the second phase processing is executed using the result of the first phase processing and the inputted second input vector to generate an output vector. According to the second embodiment, it is possible to provide a coordinate rotation processing apparatus in which the processing step is substantially halved with respect to the first embodiment when one of the two input vectors (the first input vector and the second input vector) changes.

### Third Embodiment

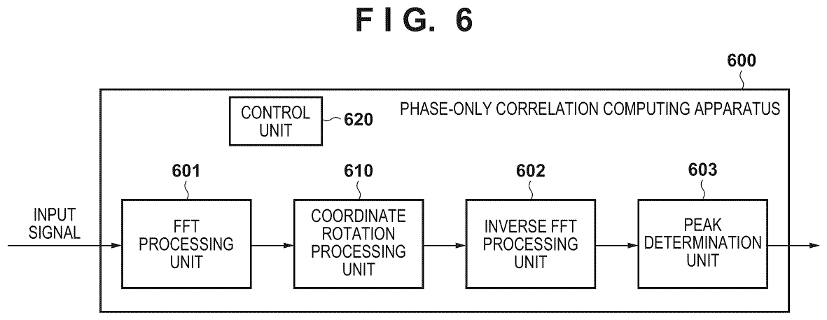

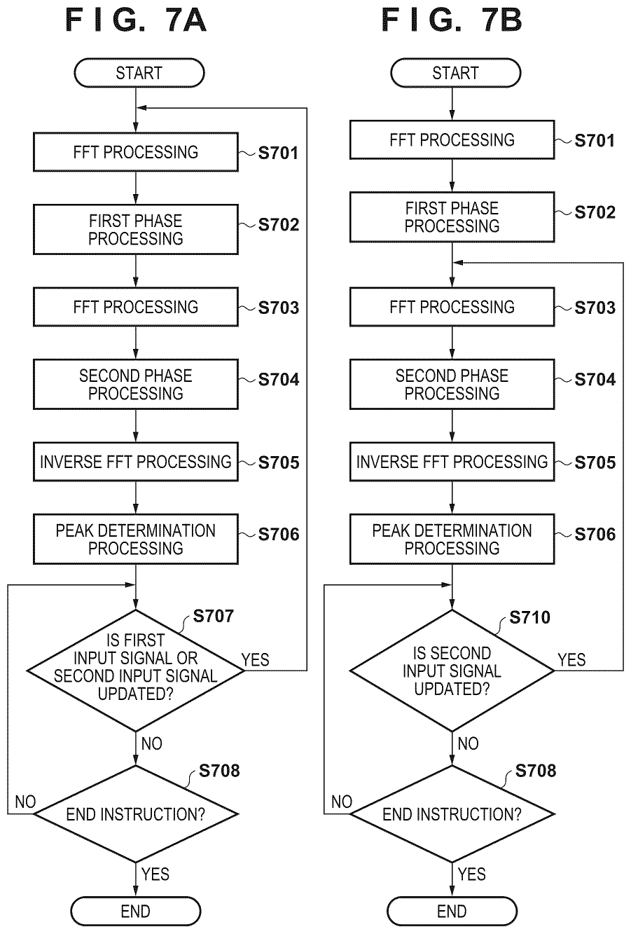

In the third embodiment, a phase-only correlation computing apparatus using the coordinate rotation processing apparatus 100 described in the first embodiment or the second embodiment will be described. Hereinafter, configurations and processing added to the first embodiment and the second embodiment will be mainly described. FIG. 6 is a block diagram illustrating a configuration example of a phase-only correlation computing apparatus 600 according to the third embodiment. The phase-only correlation computing apparatus 600 may be implemented, for example, by the data processing apparatus 110 illustrated in FIG. 1B. A coordinate rotation processing unit 610 has a similar functional configuration to the coordinate rotation processing apparatus 100 described in the first embodiment or the second embodiment. An FFT processing unit 601, the coordinate rotation processing unit 610, an inverse FFT processing unit 602, and a peak determination unit 603 operate under the control of a control unit 620, and perform the phase-only correlation computing processing. FIG. 7A is a flowchart for describing phase-only correlation computing processing performed by the phase-only correlation computing apparatus 600 according to the third embodiment.

In step S701, the FFT processing unit 601 performs a Fourier transform (FFT processing in the present embodiment) on a first input signal to generate vector information of frequency components, that is, a plurality of vectors including magnitude and phase information of respective frequencies. The plurality of vectors are used as the plurality of first input vectors of the coordinate rotation processing unit 610. Note that FFT represents a Fast Fourier Transform. The generated plurality of first input vectors are input from the FFT processing unit 601 to the coordinate rotation processing unit 610. In step S702, the coordinate rotation processing unit 610 inputs each of the plurality of first input vectors as the vector input rectangular coordinate data 10 to the CORDIC processing unit 101, and performs the first phase processing. The plurality of normalized first vectors obtained by performing the first phase processing on each of the plurality of first input vectors is held in the data holding unit 103. The first phase processing on the first input vectors is as described in the first embodiment.

Subsequently, in step S703, the FFT processing unit 601 performs FFT processing on a second input signal to generate a plurality of vectors having phase information and magnitudes for respective frequencies. The plurality of vectors is provided to the coordinate rotation processing unit 610 as second input vectors. In step S704, the coordinate rotation processing unit 610 performs second phase processing using each of the plurality of normalized first vectors held in the data holding unit 103 and each of the plurality of second input vectors inputted in step S703 to obtain a plurality of output vectors. The second phase processing is as described in the first embodiment, and the second input vectors are inputted to the CORDIC processing unit 101 as the vector input rectangular coordinate data 10, and the normalized first vector is inputted as the rotation input rectangular coordinate data 13. However, the pair of the normalized first vector and the second input vector used in the second phase processing is a pair of vectors corresponding to the same frequency among the plurality of normalized first vectors and the plurality of second input vectors.

Next, in step S705, the inverse FFT processing unit 602 performs an inverse Fourier transform on the group of output vector obtained from the coordinate rotation processing unit 610 in step S704 (an inverse fast Fourier transform is used in the present embodiment), thereby generating a phase-only correlation value. Then, in step S706, the peak determination unit 603 obtains a correlation coordinate value from the magnitude information of the phase-only correlation value. This correlation coordinate value corresponds to, for example, a relative positional deviation between two images, and can be used for various image processing such as image matching and registration. In step S707, the control unit 620 determines whether the first input signal or the second input signal has been updated as a condition for executing a subsequent new process. In the present embodiment, when it is determined that the first input signal or the second input signal has been updated (YES in step S707), the control unit 620 performs control so as to execute the above-described step S701 to step S706 processing, and acquires a correlation coordinate value for a new input signal. When a processing end instruction is received (YES in step S708), the processing ends. If it is assumed that the first signal has not been updated and the second signal has been updated, the control unit 620 may perform phase-only correlation computing processing as illustrated in FIG. 7B. That is, after performing step S701 to step S706 process, in step S710, the control unit 620 determines whether or not the second input signal has been updated. When determining that the second input signal has been updated (YES in step S710), the control unit 620 executes step S703 to step S706 to acquire a correlation coordinate value for the new second input signal.

The input signal of the phase-only correlation computing apparatus 600 may be a one-dimensional signal or a two-dimensional signal. Examples of the one-dimensional input signal include audio data, a time-series measurement result of a target to be measured, and line information of a captured image. In such cases, the FFT processing unit 601 and the inverse FFT processing unit 602 perform one-dimensional FFT processing. Also in the peak determination unit 603, the peak position is determined by one-dimensional function fitting processing or the like. Examples of the two-dimensional input signal include captured image data. For a two-dimensional input signal, FFT processing is also two-dimensionally performed, and the peak position is determined by two-dimensional fitting, for example, parabolic fitting in the peak determination unit 603.

As described above, according to the third embodiment, a phase-only correlation computing apparatus can be provided with a small circuit scale vectoring-rotation CORDIC configuration.

### Fourth Embodiment

In the fourth embodiment, a phase-only correlation computing apparatus having a configuration different from that of the third embodiment will be described. Parts different from those of the third embodiment will be mainly described.

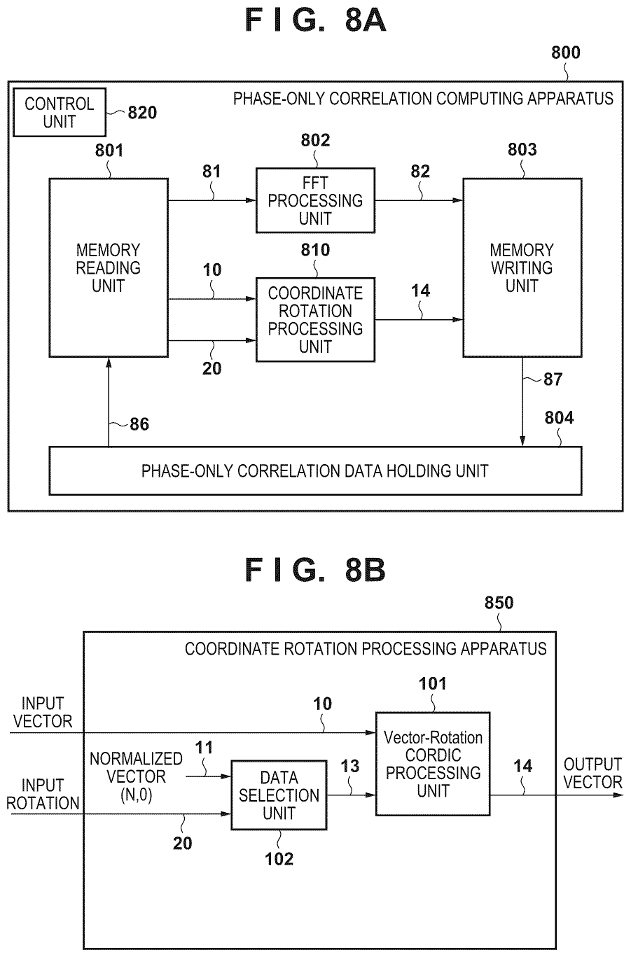

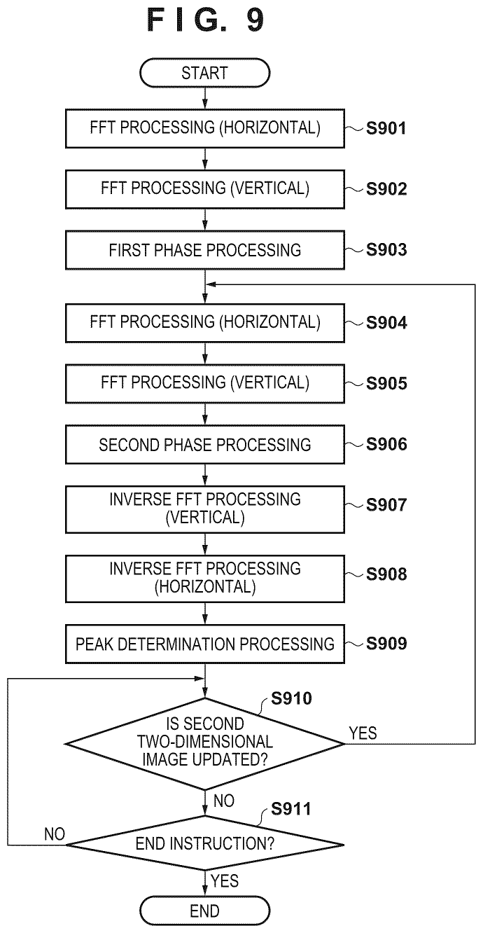

FIG. 8A is a block diagram illustrating a configuration example of a phase-only correlation computing apparatus 800 according to the fourth embodiment. The phase-only correlation computing apparatus 800 may be implemented, for example, by the data processing apparatus 110 illustrated in FIG. 1B. FIG. 8B is a block diagram illustrating a configuration example of a coordinate rotation processing unit 810 according to the fourth embodiment. FIG. 9 is a flowchart illustrating phase-only correlation computing processing for a two-dimensional image according to the fourth embodiment. The phase-only correlation computing processing is executed by the respective functional units of FIG. 8B of FIG. 8A being operated under the control of a control unit 820. Hereinafter, the configuration and processing of the phase-only correlation computing apparatus 800 will be described giving the example of processing in the case where a two-dimensional image is inputted as an input signal.

In step S901 and step S902, an FFT processing unit 802 performs FFT processing (horizontal) and FFT processing (vertical) on a first two-dimensional image. Data necessary for each processing step is stored in a phase-only correlation data holding unit 804, and a memory reading unit 801 reads input data necessary for each processing step from the phase-only correlation data holding unit 804. In step S901, the memory reading unit 801 reads the first two-dimensional image from the phase-only correlation data holding unit 804 and provides it to the FFT processing unit 802 (the phase-only correlation data holding unit 804→data 86→the memory reading unit 801→data 81→the FFT processing unit 802). Further, the processing result of the FFT processing unit 802 (processing result of step S901 and step S902) is stored in the phase-only correlation data holding unit 804 from a memory writing unit 803 (the FFT processing unit 802→data 82→the memory writing unit 803→data 87→the phase-only correlation data holding unit 804). When the size of the two-dimensional image is large, the phase-only correlation data holding unit 804 needs an accordingly large-capacity memory. In such cases, an external storage apparatus such as a DRAM may be used.

Next, in step S903, the coordinate rotation processing unit 810 performs the first phase processing. FIG. 8B illustrates a configuration example of the coordinate rotation processing unit 810. The coordinate rotation processing unit 810 has substantially the same configuration as the coordinate rotation processing apparatus 100 described in the first embodiment, but has the phase-only correlation data holding unit 804, and thus the data holding unit 103 is omitted. Accordingly, the input vector is acquired from the phase-only correlation data holding unit 804, and the normalized first vector that is the result of the first phase processing is held in the phase-only correlation data holding unit 804. The input data necessary for the processing is read from the phase-only correlation data holding unit 804 by the memory reading unit 801 and inputted to the coordinate rotation processing unit 810. In first phase processing, as described above in the third embodiment (step S702 of FIG. 7A and FIG. 7B), a normalized first vector is obtained for each of the plurality of first input vectors. The plurality of first input vectors obtained from a result of FFT processing of step S901 to step S902 are held in the phase-only correlation data holding unit 804. The memory reading unit 801 reads each of the plurality of first input vectors from the phase-only correlation data holding unit 804, and provides the vector input rectangular coordinate data 10 (input vector) to the coordinate rotation processing unit 810. That is, data is transferred as follows: the phase-only correlation data holding unit 804→data 86 (first input vector)→the memory reading unit 801→the vector input rectangular coordinate data 10→the coordinate rotation processing unit 810. The plurality of normalized first vectors, which are the processing results of the first phase processing by the coordinate rotation processing unit 810, are stored in the phase-only correlation data holding unit 804 by the memory writing unit 803. That is, data is transferred in the following manner: the coordinate rotation processing unit 810→the rotation output rectangular coordinate data 14 (normalized first vectors)→the memory writing unit 803→data 87→the phase-only correlation data holding unit 804.

In step S904 to step S905, the FFT processing unit 802 performs FFT processing (horizontally) and FFT processing (vertically) on a second two-dimensional image that differs from the first two-dimensional image, and obtains a plurality of second input vectors to be inputted to the coordinate rotation processing unit 810. The obtained plurality of second input vectors are stored in the phase-only correlation data holding unit 804 by the memory writing unit 803. The FFT processing of step S904 to step S905 is similar to the FFT processing of step S901 to step S902. In step S906, the coordinate rotation processing unit 810 performs the second phase processing using the plurality of second input vectors and the plurality of normalized first vectors. Specifically, the memory reading unit 801 reads the second input vector from the phase-only correlation data holding unit 804 and provides it to the coordinate rotation processing unit 810 (the phase-only correlation data holding unit 804→data 86→the memory reading unit 801→data 83→the coordinate rotation processing unit 810). Also, the memory reading unit 801 reads the normalized first vector from the phase-only correlation data holding unit 804 and provides it to the coordinate rotation processing unit 810 (the phase-only correlation data holding unit 804→data 86→the memory reading unit 801→data 84→the coordinate rotation processing unit 810). As described in the third embodiment, in the second phase processing, a pair of vectors corresponding to the same frequency among the plurality of second input vectors and the plurality of normalized first vectors is read from the phase-only correlation data holding unit 804 and provided to the coordinate rotation processing unit 810. The rotation output rectangular coordinate data 14 (output vectors), which are the processing results of the second phase processing by the coordinate rotation processing unit 810, are stored in the phase-only correlation data holding unit 804 by the memory writing unit 803. That is, data is transferred in the following manner: the coordinate rotation processing unit 810→the rotation output rectangular coordinate data 14 (output vectors)→the memory writing unit 803→data 87→the phase-only correlation data holding unit 804.

In step S907 and step S908, the FFT processing unit 802 performs inverse FFT processing on the group of output vector obtained by the second phase processing. The memory reading unit 801 provides the plurality of output vectors obtained by the second phase processing to the FFT processing unit 802 from the phase-only correlation data holding unit 804. That is, data (output vector) is transferred as in the phase-only correlation data holding unit 804→data 86 (output vector)→the memory reading unit 801→data 81→the FFT processing unit 802. The memory writing unit 803 stores the phase-only correlation data resulting from the inverse FFT processing performed by the FFT processing unit 802 in the phase-only correlation data holding unit 804. That is, data is transferred in the following manner: the FFT processing unit 802→data 82 (phase-only correlation data)→the memory writing unit 803→data 87→the phase-only correlation data holding unit 804.

Next, in step S909, the phase-only correlation data obtained in step S908 is subjected to peak determination processing. In the fourth embodiment, the peak determination processing is performed by the higher-level control unit 820. In step S910, the control unit 820 determines whether or not the second two-dimensional image has been updated. In the fourth embodiment, as described with reference to FIG. 7B in the third embodiment, updating occurs only in the second two-dimensional image. If the second two-dimensional image has been updated (YES in step S910), the processing returns to step S904 and the processing described above is repeated for the new second two-dimensional image. Also, when an end instruction is received (YES in step S911), the processing ends.

In the present embodiment, the FFT processing unit 802 performs FFT processing and inverse FFT processing. It is assumed that the control unit 820 instructs which of FFT processing and inverse FFT processing is to be performed by the FFT processing unit 802. For example, the control unit 820 designates an address for reading the first two-dimensional image (or the second two-dimensional image) to the memory reading unit 801, and instructs the FFT processing unit 802 to perform FFT processing. In addition, the control unit 820 instructs the memory reading unit 801 to specify an address for reading the group of output vector from the coordinate rotation processing unit 810, and also instructs the FFT processing unit 802 to perform inverse FFT processing. Note that the switching between the FFT processing and the inverse FFT processing in the FFT processing unit 802 is not limited to that according to an instruction from the control unit 820, and any method may be used as long as the FFT processing and the inverse FFT processing can be appropriately switched. For example, the two-dimensional images and the output vectors may each be provided with a bit for distinguishing between the object of FFT processing and the object of inverse FFT processing, and the FFT processing unit 802 may determine what this bit is and switch between the FFT processing and the inverse FFT processing.

As described above, in the fourth embodiment, an FFT circuit included in one FFT processing unit 802 is common to the FFT processing and the inverse FFT processing. Therefore, the FFT processing and the inverse FFT processing can share many circuit configurations. Therefore, it is possible to provide the phase-only correlation computing apparatus 800 with a smaller scale circuit configuration than the configuration of the third embodiment (FIG. 7A and FIG. 7B) which has the FFT processing unit 601 and the inverse FFT processing unit 602 separately.

### Fifth Embodiment

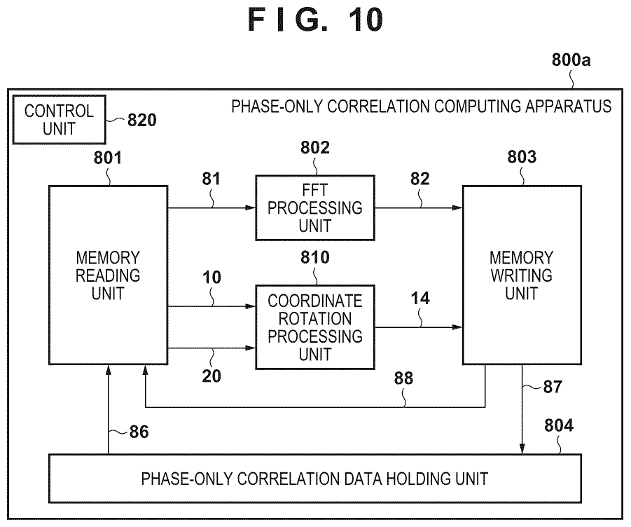

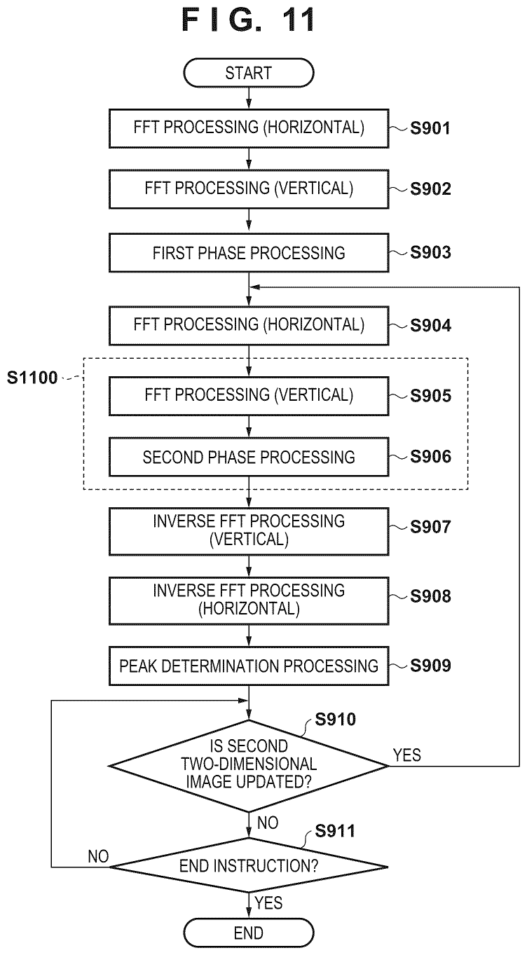

In the fourth embodiment, all the processing results of the FFT processing unit 802 and the coordinate rotation processing unit 810 are temporarily held in the phase-only correlation data holding unit 804. However, when the phase-only correlation data holding unit 804 is configured by an external storage apparatus such as a DRAM, it takes a long time to save and read data, and therefore it may be desired to reduce data access to the phase-only correlation data holding unit 804 as much as possible. In the fifth embodiment, a configuration example in which data access to the phase-only correlation data holding unit 804 is reduced will be described with respect to the fourth embodiment. FIG. 10 is a block diagram illustrating a configuration example of a phase-only correlation computing apparatus 800a according to the fifth embodiment. The phase-only correlation computing apparatus 800a may be implemented, for example, by the data processing apparatus 110 illustrated in FIG. 1B. FIG. 11 is a flowchart illustrating phase-only correlation computing processing for a two-dimensional image according to the fifth embodiment.

In the phase-only correlation computing apparatus 800a of the fifth embodiment, a data transfer path 88 from the memory writing unit 803 to the memory reading unit 801 is added to the configuration of the phase-only correlation computing apparatus 800 of the fourth embodiment (FIG. 8A). As described above, when the phase-only correlation data holding unit 804 is configured by a DRAM, data transfer times may become an issue. According to the fifth embodiment, the data transfer path 88 makes it possible to perform phase-only correlation computing processing without going through the phase-only correlation data holding unit 804 which takes a long time for data transfer.

Individual processing steps of the fifth embodiment illustrated in FIG. 11 are the same as those of the fourth embodiment (FIG. 9), but in step S1100, FFT processing (vertical) of step S905 and the second phase processing of step S906 are collectively processed without going through the phase-only correlation data holding unit 804. In FFT processing (vertical) in step S905, vector information (magnitude, phase) for each frequency is appropriately outputted as a processing result. This is the second input vector for the second phase processing (step S905). In step S906, the memory reading unit 801 acquires the second input vector via the data transfer path 88, and reads the normalized first vector corresponding to the frequency corresponding to the second input vector from the phase-only correlation data holding unit 804. Then, the second phase processing (step S406) is executed by inputting the read normalized first vector and the second input vector supplied via the data transfer path 88 to the coordinate rotation processing unit 810.

As described above, in the fifth embodiment, it is possible to reduce the processing of writing and reading the second input vector to and from the phase-only correlation data holding unit 804. As a result, the processing time of phase-only correlation computing can be reduced, or the data band associated with the phase-only correlation data holding unit 804 can be reduced.

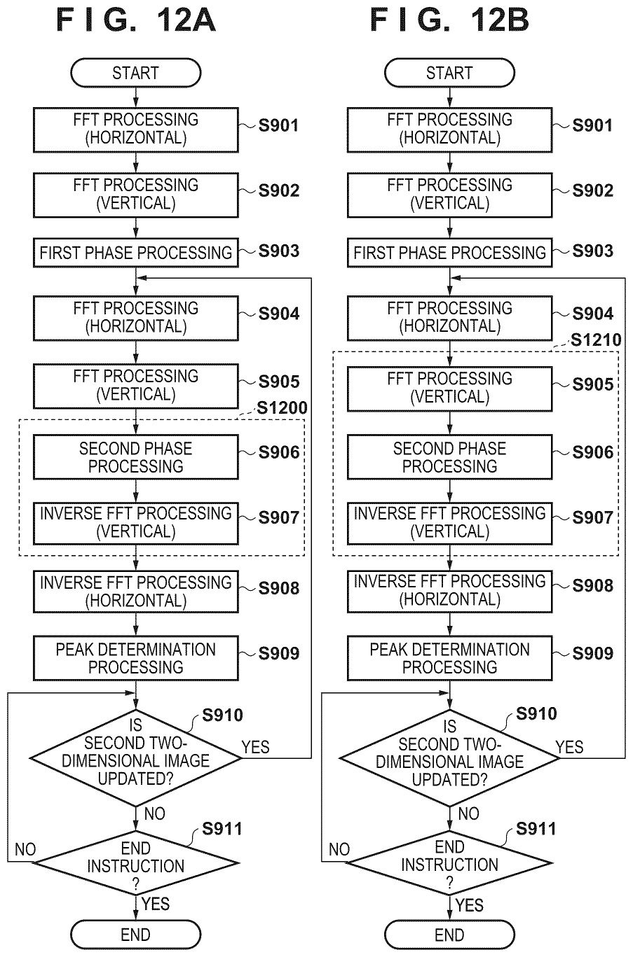

Further, as variants of the fifth embodiment, an example in which collectively processed steps differs are illustrated in FIG. 12A and FIG. 12B. In FIG. 12A, step S1200 for collectively processing the second phase processing (step S906) by the coordinate rotation processing unit 810 and the inverse FFT processing (vertical) (step S907) by the FFT processing unit 802 is provided. In step S1200, when the output vector is obtained by the second phase processing (step S906), the memory reading unit 801 obtains the output vector via the data transfer path 88 and provides the obtained output vector to the FFT processing unit 802, and the FFT processing unit 802 performs the inverse FFT processing (step S907). The content of the second phase processing and the inverse FFT processing is as described above. In addition, in FIG. 12B, FFT processing (vertical) (step S905), second phase processing (step S906), and inverse FFT processing (vertical) (step S907) are collectively processed in step S1210. Step S1210 is processing in which collective processing of step S1100 and step S1200 is combined. However, in this case, the FFT processing (vertical) of step S905 and the inverse FFT processing (vertical) of step S907 are executed simultaneously. Therefore, there is to be two FFT processing units 802, or time division processing of the FFT processing (vertical) (step S905) and inverse FFT processing (vertical) (step S907) is to be performed by the FFT processing unit 802. Meanwhile, the amount of access to the phase-only correlation data holding unit 804 can be minimized.

### Sixth Embodiment

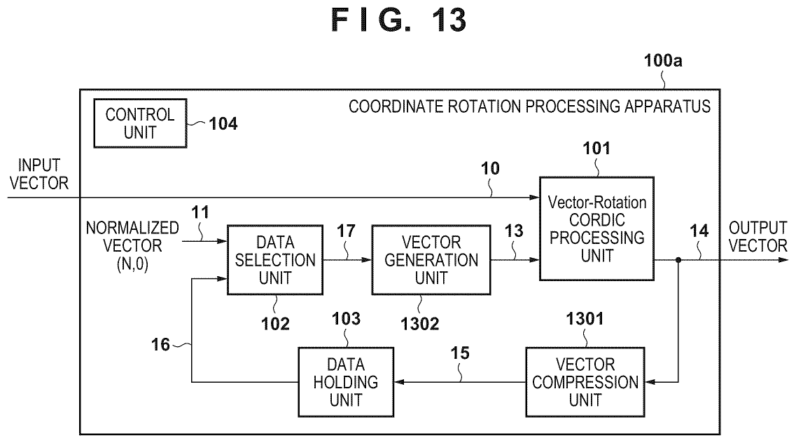

In the sixth embodiment, a configuration in which data held in the data holding unit 103 is reduced in the coordinate rotation processing apparatus will be described. FIG. 13 is a block diagram illustrating a configuration example of a coordinate rotation processing apparatus 100a according to the sixth embodiment. The coordinate rotation processing apparatus 100a may be implemented, for example, by the data processing apparatus 110 illustrated in FIG. 1B. In the coordinate rotation processing apparatus 100a, a vector compression unit 1301 and a vector generation unit 1302 are added to the configuration (FIG. 1A) of the coordinate rotation processing apparatus 100 of the first embodiment.

The vector compression unit 1301 reduces the data amount of the normalized first vector generated by the first phase processing (step S401) (either the X axis or the Y axis data in a rectangular coordinate system, or either the real part or imaginary part data in the case of a complex number representation). In the present embodiment, the X axis data is used. More specifically, of the normalized first vectors, only quadrant data (2 bits), which is the signs of the X axis data and the Y axis data, and the X axis data (unsigned), are supplied as compressed data 15 to the data holding unit 103. Among the Y axis data, data other than the sign data is discarded. In the second phase processing (step S402), the compressed data 15 stored in the data holding unit 103 is read out as the data 16, and the data selection unit 102 selects this data and inputs it as selected compressed data 17 to the vector generation unit 1302.

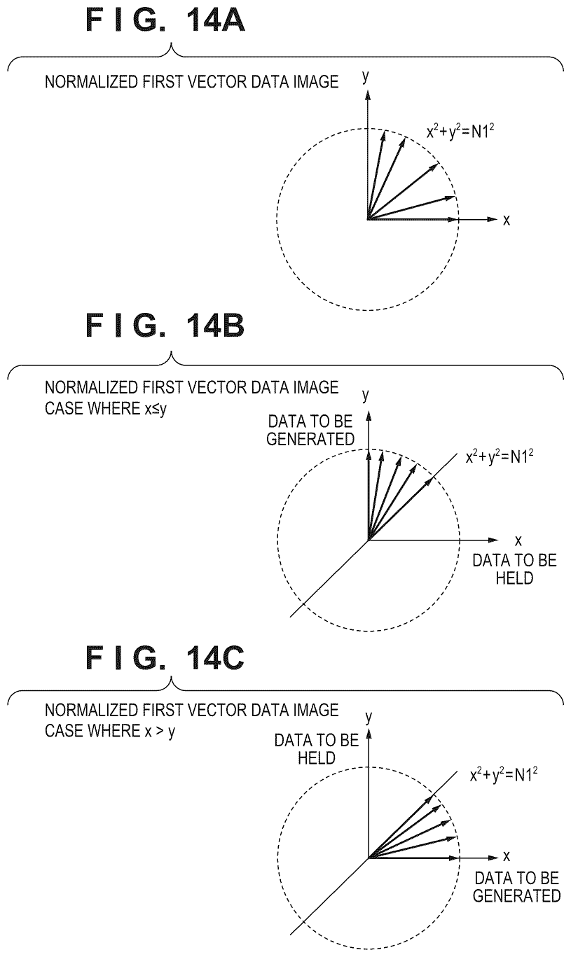

The vector generation unit 1302 generates Y axis data from the X axis data of the selected compressed data 17, adds quadrant data (2 bits) to restore the normalized first vector, and inputs the normalized first vector to the CORDIC processing unit 101 as the rotation input rectangular coordinate data 13. A Y axis data generation method (vector restoration method) in the vector generation unit 1302 is as follows. The normalized first vector is normalized by the magnitude N1 as described above. That is, as illustrated in FIG. 14A, the normalized first vector is a vector indicating a position of a circular orbit having a length N1 as a radius in the rectangular coordinate system. Therefore, Y axis data (=√(N1²−(X axis data)²)) can be generated from N1 and the X axis data. Specific examples of the method of generating the Y axis data include calculation using a theoretical function or an approximate function of a circular orbit, or data generation using a look-up table and interpolation processing.

As described above, in the sixth embodiment, by setting the normalized first vector to only the X axis data or the Y axis data, the data amount and the transfer data amount held in the data holding unit 103 can be reduced. In addition, the memory size used for the data holding unit 103 can be reduced. In addition, the configuration of the sixth embodiment can obviously be applied to the phase-only correlation computing apparatus of the third embodiment to the fifth embodiment, and in this case, the amount of data held in the phase-only correlation data holding unit 804 and the transfer data amount can be reduced.

### Seventh Embodiment

The seventh embodiment is another embodiment similar to the sixth embodiment, and relates to a method for improving the accuracy of the polar angle at the time of compression. Parts that are changed from the sixth embodiment will be mainly described.

In the sixth embodiment, only the data of the X axis and the Y axis is used as the compressed data, whereas in the seventh embodiment, the smaller of the X axis and the Y axis is used as the compressed data. Specifically, the vector compression unit 1301 supplies the following three pieces of data out of the normalized first vector to the data holding unit 103 as the compressed data 15.
Quadrant data (2 bits) representing the sign of the X axis data and Y axis data.
Smallest data (unsigned), which is the smaller of the X axis data and the Y axis data.
Flag data (1 bit), which is a flag indicating whether the data is the X axis data or Y axis data.

In the second phase processing (step S402), the data selection unit 102 reads the compressed data 15 stored in the data holding unit 103 as data 16, selects it as the selected compressed data 17, and inputs it to the vector generation unit 1302. The vector generation unit 1302, from the magnitude N1 of the normalized first vector and the smallest data, which is the data of one of the axes, generates largest data, which is the data of the other axis. Next, based on the flag data, the smallest data and the largest data or the largest data and the smallest data are assigned to the X axis data and the Y axis data. Further, quadrant data (2 bits) is added thereto and inputted to the CORDIC processing unit 101 as the rotation input rectangular coordinate data 13.

A Y axis data generation method performed by the vector generation unit 1302 is as follows. The normalized first vector is normalized by the magnitude N1 as described above, that is, the normalized first vector is a vector indicating a point on a circular orbit having the length N1 as a radius in the rectangular coordinate system as illustrated in FIG. 14A. Thus, Y axis data can be generated from the X axis data. However, in a vector having a small polar angle, that is, in a region close to the X axis, the change in the Y axis data is large with respect to the change in the X axis data. Therefore, when the Y axis data is generated from the X axis, the reproduction accuracy of the polar angle of the generated vector suffers, or the bit width of the X axis data is to be increased in order to improve the accuracy.

Therefore, in the seventh embodiment, when the X axis data is smaller (x≤y) as illustrated in FIG. 14B, that is, when the polar angle is 45° to 90°, the X axis data is held, and the Y axis data is generated from the X axis data. When the polar angle is in the range of 45° to 90°, the change of the Y axis data is small with respect to the change of the X axis data, in other words, the X axis data is dominant with respect to the generated vector. Therefore, since the vector generation unit 1302 generates the Y axis data using the X axis data, which is dominant, the reproduction accuracy of the generated vector is increased. Meanwhile, as illustrated in FIG. 14C, when the Y axis data is smaller (x>y), that is, when the polar angle is 0° to 45°, the Y axis data is held, and the X axis data is generated from the held Y axis data. In the range of 0° to 45°, the change of the X axis data is small with respect to the change of the Y axis data, in other words, the Y axis data is dominant with respect to the generated vector. Therefore, since the vector generation unit 1302 generates the X axis data using the Y axis data, which is dominant, the reproduction accuracy of the generated vector is increased.

As described above, in the seventh embodiment, by setting the data held in the data holding unit 103 to the smaller of the X axis data and the Y axis data and the flag data, the amount of data to be held, that is, the amount of transfer data and the memory size can be reduced. Further, it is possible to improve the accuracy of the generated rotation input rectangular coordinate data 13.

### Eighth Embodiment

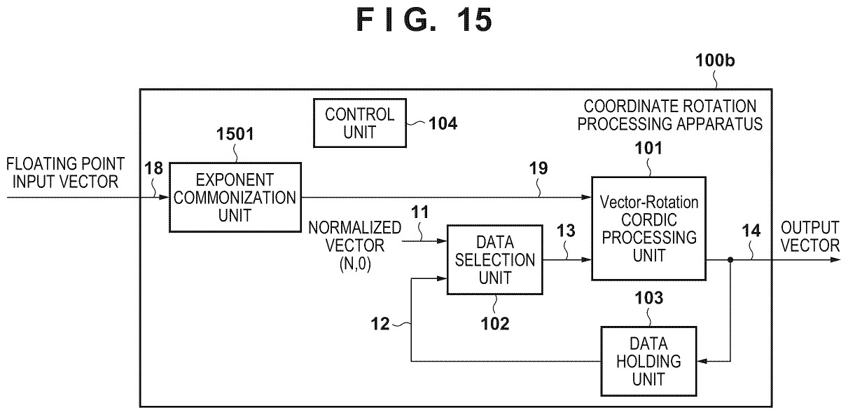

In the eighth embodiment, input data to the CORDIC processing unit 101 is reduced in the coordinate rotation processing apparatus. FIG. 15 is a block diagram illustrating a configuration example of the coordinate rotation processing apparatus 100b according to the eighth embodiment. The coordinate rotation processing apparatus 100b may be implemented, for example, by the data processing apparatus 110 illustrated in FIG. 1B. An exponent commonization unit 1501 is added to the configuration (FIG. 1A and FIG. 1B) of the first embodiment. Further, it is assumed that the vector data (the first input vector and the second input vector) inputted to the coordinate rotation processing apparatus 100b is floating point input rectangular coordinate data 18 in floating point format. For example, as described in the third embodiment, when FFT processing is performed in the preceding stage of the coordinate rotation processing apparatus 100b, a floating point operation may be performed in order to perform FFT processing with high accuracy. However, when the floating point data is inputted and the processing is performed as it is, the processing in the CORDIC processing unit 101 is also performed in floating point format, which increases the circuit scale. Because double precision floating point numbers are 64 bits and single precision floating point numbers are 32 bits, the amount of data is large. Therefore, in the eighth embodiment, there is the exponent commonization unit 1501, which transforms the floating point input rectangular coordinate data into common exponent floating point input rectangular coordinate data.

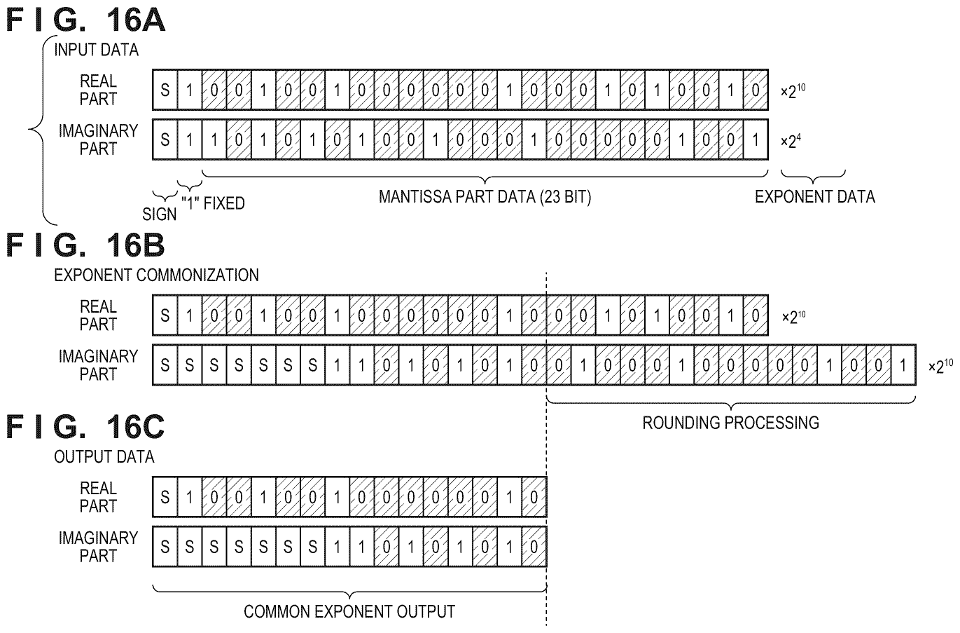

The outline of the processing performed by the exponent commonization unit 1501 is illustrated in FIG. 16A, FIG. 16B, and FIG. 16C. In FIG. 16A, an example is given of a case where the floating point input rectangular coordinate data (real part data and imaginary part data) is a single precision floating point number. That is, there is a 1 bit sign, a 23 bit mantissa part, and an 8 bit exponent. Further, in the illustrated example of the floating point data, the exponent of the real part is 10 (the tenth power of 2), the exponent of the imaginary part is 4 (the fourth power of 2), and the real part is larger.

The exponent commonization unit 1501 performs digit adjustment by performing shift processing (bit shift) on the data of the mantissa part in accordance with the larger exponent. For example, in FIG. 16B, by shifting the data of the imaginary part to the right by 6 bits, the exponent of the data of the real part and the imaginary part can be made the same (210) and the digits can be matched. Further, as illustrated in FIG. 16C, the exponent commonization unit 1501 outputs predetermined digit positions of data obtained by performing rounding at a predetermined digit position as input rectangular coordinate data (output data) represented by a floating point number in which the exponent is commonized. At this time, the exponent data is excluded and is not used in the subsequent processing. The reason why such a process is effective is that what is required as the information of the vector pipeline of the CORDIC processing unit 101 is the information of the polar angle; that is, the information of the ratio between the real part and the imaginary part, and the vector magnitude information is not required.

As described above, according to the eighth embodiment, it is possible to reduce the amount of data inputted to the CORDIC processing unit 101. Specifically, in the example given in the embodiment, 64 bits of data, which is the total of 32 bit floating point data for each of the real part and the imaginary part, can be transformed and compressed into 32 bits of data, which is the total of 16 bits of integer type data for each of the real part and the imaginary part.

Note that the processing of the exponent commonization unit 1501 may be arranged outside the coordinate rotation processing apparatus 100b. In particular, when the input data of the coordinate rotation processing apparatus 100b is once stored in a memory or the like, the amount of data can be reduced by the processing of the exponent commonization unit 1501 prior to storage in the memory, and the memory capacity and the amount of data transferred can be reduced.

The above-described embodiments merely illustrate concrete examples for carrying out the disclosure, and the technical scope of the disclosure should not be construed to be limited by these embodiments. That is, the aspect of the embodiments can be implemented in various forms without departing from the technical idea or main features thereof. Each embodiment may be implemented in combination.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-202190, filed Nov. 29, 2023, which is hereby incorporated by reference herein in its entirety.

What is claimed is:

1. An apparatus, comprising:
a calculating processing unit configured to, in accordance with input of two vectors, output a vector having a polar angle that is a result of rotating one of the two vectors by a polar angle of another one of the two vectors and a magnitude that is a result of multiplying a scaling factor with a magnitude of the one of the two vectors;
a first processing unit configured to, using the calculating processing unit, from a first input vector and a normalized vector whose rectangular coordinates are represented by (N, 0), generate a normalized first vector having a polar angle of the first input vector and a magnitude that is a result of multiplying the scaling factor with a magnitude of the normalized vector; and
a second processing unit configured to, using the calculating processing unit, from a second input vector and the normalized first vector, generate an output vector having a polar angle that is a result of rotating the normalized first vector by a polar angle of the second input vector and a magnitude that is a result of multiplying the scaling factor with a magnitude of the normalized first vector.

2. The apparatus according to claim 1, wherein
the scaling factor is a factor that depends on a number of rotations of the calculating processing unit, and is represented by (1+2⁻²ⁱ)^{1/2}, where i is the number of rotations.

3. The apparatus according to claim 1, wherein
the first processing unit inputs the first input vector and the normalized vector into the calculating processing unit and obtains the normalized first vector by rotating the normalized vector in a direction of the polar angle of the first input vector, and the second processing unit, by inputting the second input vector and a vector that is a conjugate of the normalized first vector into the calculating processing unit, obtains the output vector, whose polar angle is a difference between the polar angles of the first input vector and the second input vector.

4. The apparatus according to claim 1, wherein
the first processing unit inputs the first input vector and the normalized vector into the calculating processing unit and obtains the normalized first vector by rotating the normalized vector in a direction opposite that of the polar angle of the first input vector, and the second processing unit, by inputting the second input vector and the normalized first vector into the calculating processing unit, obtains the output vector, which is rotated in the same direction as the polar angle of the second input vector, to thereby obtain the output vector, whose polar angle is a difference between the polar angles of the first input vector and the second input vector.

5. The apparatus according to claim 1, further comprising
a control unit configured to perform control so that, in accordance with updating of the first input vector or the second input vector, each of the first processing unit and the second processing unit execute processing to thereby generate the output vector.

6. The apparatus according to claim 1, further comprising
a control unit configured to perform control so that the first processing unit, in accordance with input of the first input vector, executes processing, and after the first processing unit has executed processing, the second processing unit, in accordance with input of the second input vector or updating of the second input vector, executes processing and generates the output vector.

7. The apparatus according to claim 1, further comprising
a compression unit, configured to, from rectangular coordinate data representing the normalized first vector, using data of one of two axes of the rectangular coordinate data and not using data of another one of the two axes of the rectangular coordinate data, generate compressed data representing the normalized first vector, and hold the compressed data in a holding unit; and
a generation unit configured to, by generating data of the another one of the two axes of the rectangular coordinate data based on the compressed data held in the holding unit, restore the normalized first vector, and provide the restored normalized first vector to the second processing unit.

8. The apparatus according to claim 7, wherein
among the rectangular coordinate data representing the normalized first vector, the rectangular coordinate data with a smaller value is used as the one of the two axes of the rectangular coordinate data.

9. The apparatus according to claim 7, wherein
the generation unit, to generate the data of the another one of the two axes of the rectangular coordinate data from the compressed data, uses a function of a circular orbit whose radius is made to be a magnitude of the normalized first vector, or a function that approximate the circular orbit, or a look-up table.

10. The apparatus according to claim 1, further comprising
a commonizing unit configured to commonize an exponent of first data and an exponent of second data, wherein the first data and the second data are represented in floating point form, and the first data and the second data constitute rectangular coordinate data representing a vector, and to provide to the calculating processing unit the rectangular coordinate data for which the exponent of the first data and the exponent of the second data are commonized.

11. The apparatus according to claim 10, wherein the commonizing unit,
adjusts a value of the exponent of a smaller one of the first data and the second data to the value of the exponent of a larger one of the first data and the second data; and
by bit shifting data of a mantissa part of the smaller one of the first data and the second data by an amount that the value of the exponent of the smaller one of the first data and the second data has been adjusted to the value of the exponent of the larger one of the first data and the second data, generate data of a mantissa part of the smaller one of the first data and the second data.

12. The apparatus according to claim 11, wherein
the commonizing unit rounds off each of the data of the mantissa part of the first data and the data of the mantissa part of the second data to a predetermined digit position.

13. The apparatus according to claim 11, wherein
the commonizing unit excludes the values of the exponent of the first data and the second data from the rectangular coordinate data for which the values of the exponent of the first data and the second data have been commonized and provides the rectangular coordinate data of which the values of the exponent of the first data and the second data have been excluded to the calculating processing unit.

14. An apparatus, comprising:
a transformation unit configured to perform a Fourier transform on an inputted signal, and to obtain a vector representing a magnitude and a phase for each frequency of the transformed data;
a coordinate rotation processing unit configured to
by executing calculating processing to, in accordance with input of two vectors, output a vector having a polar angle that is a result of rotating one of the two vectors by a polar angle of another one of the two vectors and a magnitude that is a result of multiplying a scaling factor with a magnitude of the one of the two vectors,
from a first input vector obtained from a first signal by the transformation unit and a normalized vector whose rectangular coordinates are represented by (N, 0), generate a normalized first vector having a polar angle of the first input vector and a magnitude that is a result of multiplying the scaling factor with a magnitude of the normalized vector; and
from a second input vector obtained from a second signal by the transformation unit and the normalized first vector, generate an output vector having a polar angle that is a result of rotating the normalized first vector by a polar angle of the second input vector and a magnitude that is a result of multiplying the scaling factor with a magnitude of the normalized first vector;
a transformation unit configured to perform an inverse Fourier transform on the output vector to generate phase-only correlation data; and
a generation unit configured to, based on the phase-only correlation data, generate a correlation coordinate value of the first signal and the second signal.

15. The apparatus according to claim 14, wherein
the first signal and the second signal are one-dimensional data, the transformation unit performs a one-dimensional fast Fourier transform (FFT processing), and the inverse transformation unit performs a one-dimensional inverse fast Fourier transform (inverse FFT processing).

16. The apparatus according to claim 14, wherein
the first signal and the second signal are two-dimensional data, the transformation unit performs two-dimensional fast Fourier transform (FFT processing), and the inverse transformation unit performs inverse fast Fourier transform (inverse FFT processing).

17. The apparatus according to claim 14, wherein
the transformation unit executes fast Fourier transform (FFT processing) by using an FFT circuit,
and the inverse transformation unit executes inverse fast Fourier transform (inverse FFT processing) by using the FFT circuit.

18. The apparatus according to claim 14, further comprising
a holding unit configured to temporarily hold the first input vector and the second input vector obtained from the transformation unit in order to provide the first input vector and the second input vector to the coordinate rotation processing unit, and to temporarily hold the output vector obtained from the coordinate rotation processing unit in order to provide the output vector to the inverse transformation unit.

19. The apparatus according to claim 14, further comprising
a holding unit configured to temporarily hold the first input vector obtained from the transformation unit in order to provide the first input vector to the coordinate rotation processing unit, and to temporarily hold the output vector obtained from the coordinate rotation processing unit in order to provide the output vector to the inverse transformation unit; and
a data transfer path configured to provide the second input vector obtained from the transformation unit to the coordinate rotation processing unit without causing the second input vector to be held in the holding unit.

20. The apparatus according to claim 14, further comprising
a holding unit configured to temporarily hold the first input vector and the second input vector obtained from the transformation unit in order to provide the first input vector and the second input vector to the coordinate rotation processing unit;
and a data transfer path configured to provide the output vector obtained from the coordinate rotation processing unit to the inverse transformation unit without causing the output vector to be held in the holding unit.

21. The apparatus according to claim 14, further comprising
a holding unit configured to temporarily hold the first input vector obtained from the transformation unit in order to provide the first input vector to the coordinate rotation processing unit; and
a data transfer path configured to provide the second input vector obtained from the transformation unit to the coordinate rotation processing unit without causing the second input vector be to held in the holding unit, and to provide the output vector obtained from the coordinate rotation processing unit to the inverse transformation unit without causing the output vector to be held in the holding unit.

22. A method, comprising:
executing calculating processing to, in accordance with input of two vectors, output a vector having a polar angle that is a result of rotating one of the two vectors by a polar angle of another one of the two vectors and a magnitude that is a result of multiplying a scaling factor with a magnitude of the one of the two vectors,
from a first input vector and a normalized vector whose rectangular coordinates are represented by (N, 0), generating a normalized first vector having a polar angle of the first input vector and a magnitude that is a result of multiplying the scaling factor with a magnitude of the normalized vector; and
from a second input vector and the normalized first vector, generating an output vector having a polar angle that is a result of rotating the normalized first vector by a polar angle of the second input vector and a magnitude that is a result of multiplying the scaling factor with a magnitude of the normalized first vector.

23. A method, comprising:
performing a transformation, in which a Fourier transform is performed on an inputted signal, to obtain a vector representing a magnitude and a phase for each frequency of the transformed data;
using a vector obtained from a first signal by the transformation as a first input vector and a vector obtained from a second signal by the transformation as a second input vector, by executing calculating processing to, in accordance with input of two vectors, the first input vector and the second input vector, output a vector having a polar angle that is a result of rotating one of the two vectors by a polar angle of another one of the two vectors and a magnitude that is a result of multiplying a scaling factor with a magnitude of the one of the two vectors,
from the first input vector and a normalized vector whose rectangular coordinates are represented by (N, 0), generating a normalized first vector having a polar angle of the first input vector and a magnitude that is a result of multiplying the scaling factor with a magnitude of the normalized vector; and
from the second input vector and the normalized first vector, generating an output vector having a polar angle that is a result of rotating the normalized first vector by a polar angle of the second input vector and a magnitude that is a result of multiplying the scaling factor with a magnitude of the normalized first vector;
performing an inverse Fourier transform on the output vector to generate phase-only correlation data; and
based on the phase-only correlation data, generating a correlation coordinate value of the first signal and the second signal.

24. A non-transitory computer readable storage medium that stores a program for causing a computer included in an apparatus to perform a method comprising:
executing calculating processing to, in accordance with input of two vectors, output a vector having a polar angle that is a result of rotating one of the two vectors by a polar angle of another one of the two vectors and a magnitude that is a result of multiplying a scaling factor with a magnitude of the one of the two vectors,
from a first input vector and a normalized vector whose rectangular coordinates are represented by (N, 0), generating a normalized first vector having a polar angle of the first input vector and a magnitude that is a result of multiplying the scaling factor with a magnitude of the normalized vector; and
from a second input vector and the normalized first vector, generating an output vector having a polar angle that is a result of rotating the normalized first vector by a polar angle of the second input vector and a magnitude that is a result of multiplying the scaling factor with a magnitude of the normalized first vector.

25. A non-transitory computer readable storage medium that stores a program for causing a computer included in a phase-only correlation computing apparatus to perform a method comprising:
performing a transformation, in which a Fourier transform is performed on an inputted signal, to obtain a vector representing a magnitude and a phase for each frequency of the transformed data;
using a vector obtained from a first signal by the transformation as a first input vector and a vector obtained from a second signal by the transformation as a second input vector, by executing calculating processing to, in accordance with input of two vectors, the first input vector and the second input vector, output a vector having a polar angle that is a result of rotating one of the two vectors by a polar angle of another one of the two vectors and a magnitude that is a result of multiplying a scaling factor with a magnitude of the one of the two vectors;
from the first input vector and a normalized vector whose rectangular coordinates are represented by (N, 0), generating a normalized first vector having a polar angle of the first input vector and a magnitude that is a result of multiplying the scaling factor with a magnitude of the normalized vector; and
from the second input vector and the normalized first vector, generating an output vector having a polar angle that is a result of rotating the normalized first vector by a polar angle of the second input vector and a magnitude that is a result of multiplying the scaling factor with a magnitude of the normalized first vector;
performing an inverse Fourier transform on the output vector to generate phase-only correlation data; and
based on the phase-only correlation data, generating a correlation coordinate value of the first signal and the second signal.
